(19) United States
(12) Patent Application Publication
(10) Pub. No.: US 2017/0070470 A9
(43) Pub. Date: Mar. 9, 2017

(54) Automatic, Interest-Based Notifications

(71) Applicant: YAPMO Inc., Chicago, IL (US)

(72) Inventors: Paul Everton, Chicago, IL (US); Erich Luedtke, Chicago, IL (US); Raymond Elward, Chicago, IL (US)

(73) Assignee: YAPMO LLC, Chicago, IL (US)

(21) Appl. No.: 14/213,020

(22) Filed: Mar. 14, 2014

Related U.S. Application Data
(63) Continuation-in-part of application No. 13/757,937, filed on Feb. 4, 2013, now abandoned.
Application No. 13/757,937 is a continuation-in-part of application No. 13/972,092, filed on Aug. 21, 2013, now abandoned.
(60) Provisional application No. 61/787,342, filed on Mar. 15, 2013.
(60) Provisional application No. 61/594,204, filed on Feb. 2, 2012.
(60) Provisional application No. 61/845,319, filed on Jul. 11, 2013.

(51) Int. Cl. H04L 12/58

(52) U.S. Cl. CPC H04L 51/32

(57) ABSTRACT

A system which hosts an electronic forum comprises memory in which is stored profiles of users of the electronic forum, memory in which is stored posts of the electronic forum, and notification generation circuitry. The notification generation circuitry is operable to, automatically in response to creation of a post to the electronic forum, inspect the post for an occurrence of a particular tag. The notification generation circuit is operable to determine, automatically in response to a detection that the post contains an occurrence of the particular tag, which of the users are both subscribed to the particular tag and have permission to view the post; and send, automatically in response to a determination that a first one or more of the users are both subscribed to the particular tag and have permission to view the post, a notification of the post to the first one or more of the users.

### PRIORITY CLAIM

This application claims priority to the following application(s), each of which is hereby incorporated herein by reference:

U.S. provisional patent application 61/787,342 titled “Real-Time, Interest-Based Notifications” filed on Mar. 15, 2013.

### INCORPORATION BY REFERENCE

This application claims priority to the following application(s), each of which is hereby incorporated herein by reference:

U.S. patent application Ser. No. 13/972,092 titled “Electronic Forum with Structured Data” filed on Aug. 21, 2013.

### BACKGROUND

Conventional methods and systems for notifications provide poor user experiences. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for automatic, interest-based notifications, substantially as shown in and/or described in connection with at least one of the figures, as set forth more completely in the claims.

Advantages, aspects and novel features of the present invention, as well as details of one or more illustrated embodiment(s) thereof, will be more fully understood from the following description and drawings.

### BRIEF DESCRIPTION OF SEVERAL VIEWS OF THE DRAWINGS

FIG. 1A depicts an example computing environment for an electronic forum with automatic, interest-based notifications.

FIG. 1B is a high-level block diagram of a device that hosts an electronic forum in accordance with an example implementation of this disclosure.

FIGS. 2A-2C show an example user interface of an electronic forum.

FIG. 3 shows an example user profile screen of the electronic forum.

FIG. 4 is a flowchart illustrating an example process for real-time, interest-based notifications, in accordance with an example implementation of this disclosure.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

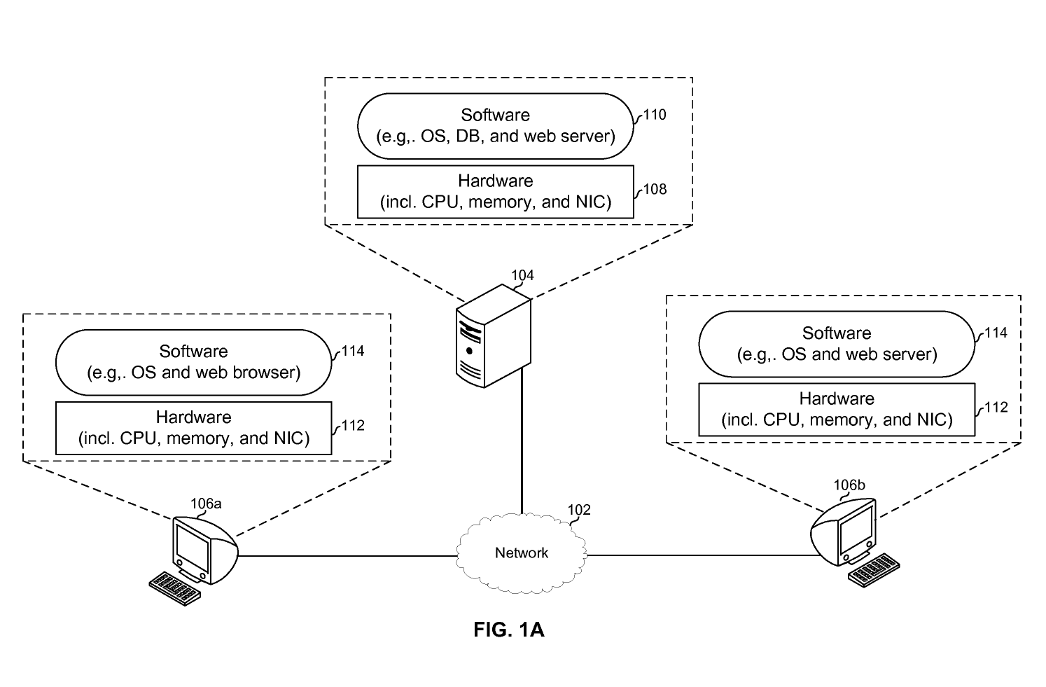

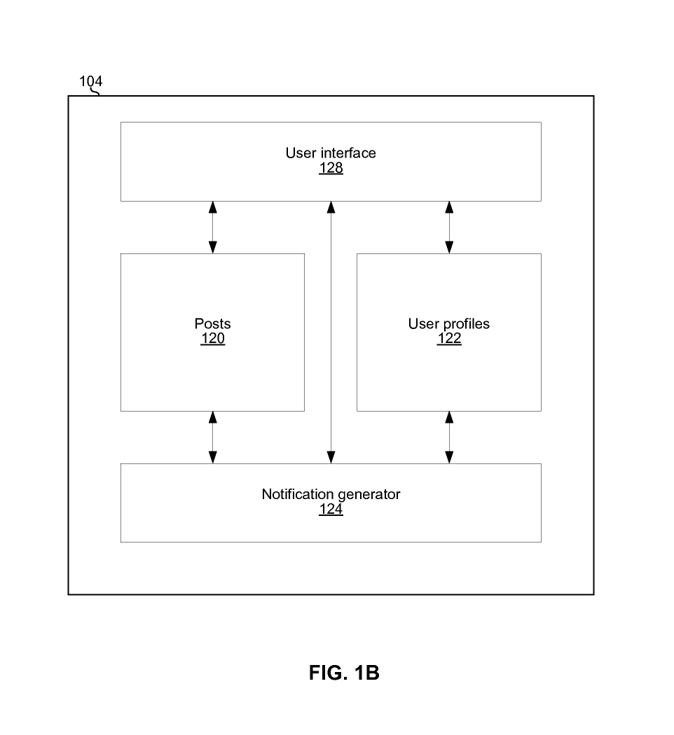

FIG. 1A depicts an example computing environment for an electronic forum with automatic, interest-based notifications. Shown are a network 102, a computing device 104, and computing devices 106a and 106b. Examples of computing devices include: desktop computers, laptop computers, tablet computers, smartphones, stand-alone servers, rack-mounted servers, and the like. In an example implementation, the computing device 104 may operate as a web and/or application server (e.g., may be a stand-alone or rack-mounted server), and the computing devices 106a-106b may each operate as an end-system (e.g., may be a personal computer, tablet computer, or a smart phone).

The network 102 may comprise a local area network and/or a wide area network. The network 102 may comprise, for example, network “plumbing” such as routers, switches, cables, etc. The network 102 may be, for example, the Internet and/or an Ethernet-based LAN.

The computing device 104 may comprise circuitry operable to process (e.g., read from memory, perform logic and/or arithmetic operations on, packetize according to one or more communication protocols, and/or the like) data to be sent via a network connection, send data via a network connection, receive data via a network connection, and process (e.g., write to memory, perform logic and/or arithmetic operations on, depacketize according to one or more communication protocols, and/or the like) data received via a network connection. Such data may include, for example, data formatted and communicated in accordance with one or more Internet-related standards (e.g., HTML, HTTP, TCP/IP, etc.), and/or in one or more vendor-specific Application Programming Interfaces (APIs). Such circuitry may enable each of the computing device 104a to operate as a web server and/or a vendor-specific application server.

The memory circuitry may comprise, for example, SRAM, DRAM, ROM, FLASH, magnetic storage, and/or any other suitable type of memory. The memory circuitry may store program memory, run-time memory, and/or mass storage. The memory circuitry may store data associated with an electronic forum hosted by the device (e.g., HTML files, CSS files, script files, posted content, user profiles, and/or the like.). Posts to the electronic forum may be stored, for example, as structured data (e.g., in a table, database, or the like). The user profiles may include, for example, biographical information, user preferences, a user activity log, and/or user attributes. The biographical information may include, for example, name, address, contact info, work title, and/or the like. The user preferences may include, for example, the user's subscriptions. A user's subscriptions determine which posts that the user is automatically notified of. In this regard, as described further below, the electronic forum may enable its users to subscribe to particular tags, to particular users, and/or to particular combinations of tags and/or users. The users may then be automatically notified (e.g., via a push notification to an app on their smartphone) upon creation of a post in the electronic forum that contains a tag, mention, or combination thereof to which the user is subscribed.

The circuitry of the computing device 104 may comprise, for example hardware 108 and software 110. The hardware 108 may comprise, for example, a CPU, memory circuitry, and network interface circuitry (NIC). The software 110 may comprise, for example, an operating system, one or more database applications, and a web server application. The database application(s) may, for example, store, organize, and/or provide access to data of an electronic forum and/or CRM data. The web server may, for example, serve a graphical user interface of the electronic forum.

The CPU may comprise, for example an x86-based processor, an ARM-based processor, or any other suitable circuitry operable to execute instructions (e.g., stored in the memory of hardware 108) for processing data, generating control signals, and/or otherwise performing, or causing other circuits to perform, functions described herein. In this manner, an operating system and one or more software applications may run on the computing device 104. Such software applications may include, for example, a web server, an application server, and/or processes for performing various aspects of a communication protocol (e.g., for implementing TCP/IP and interfacing the applications to the network 102).

The network interface circuitry may be operable to transmit and receive physical layer signals via the network. In the receive direction, the network interface circuitry may convert the signals to packets of binary data, and output the packets to the CPU and/or memory for processing. The network interface circuitry may, for example, receive signals in accordance with Ethernet physical layer protocols, assemble the signals to IP packets and output the IP packets to the CPU and/or memory. In the transmit direction, the network interface circuitry may receive IP packets from the CPU and/or memory, encapsulate the IP packets into Ethernet frames, and transmit the frames into the network 102 in accordance with Ethernet physical layer protocols.

In operation, the computing device 104 may operate as a web server to host an electronic forum and user interface via which users can interact with the electronic forum as, for example, described below with reference to FIGS. 1B-4.

Each of the computing devices 106a and 106b may comprise circuitry operable to process (e.g., read from memory, perform logic and/or arithmetic operations on, packetize according to one or more communication protocols, and/or the like) data to be sent via a network connection, send data via a network connection, receive data via a network connection, process (e.g., write to memory, perform logic and/or arithmetic operations on, depacketize according to one or more communication protocols, and/or the like) data received via a network connection. Such data may include, for example, data formatted and communicated in accordance with one or more Internet-related standards (e.g., HTML, HTTP, TCP/IP, etc.), and/or in one or more vendor-specific Application Programming Interfaces (APIs). Such circuitry may enable each of the end-systems 106a-106c to operate as a web client, and/or run a vendor-specific application client. Additionally or alternatively, the circuitry may enable the computing devices 106a and 106b to present web-based content to a user (e.g., via speakers and/or a monitor) and accept input from a user (e.g., via touchscreen, keyboard, mouse, and/or the like).

The circuitry of the computing devices 106 may comprise, for example hardware 112 and software 114. The hardware 112 may comprise, for example, a CPU, memory circuitry, and network interface circuitry (NIC). The software 114 may comprise, for example, an operating system, a web browser application, and/or a vendor-specification client application (e.g., an electronic forum client application).

The memory circuitry may comprise, for example, SRAM, DRAM, ROM, FLASH, magnetic storage, and/or any other suitable type of memory. The memory circuitry may store program memory, run-time memory, and/or mass storage.

The CPU may comprise, for example an x86-based processor, an ARM-based processor, or any other suitable circuitry operable to execute instructions (e.g., stored in the memory of hardware 112) for processing data, generating control signals, and/or otherwise performing, or causing other circuits to perform, functions described herein. In this manner, an operating system and one or more software applications may run on each computing device 106. Such software applications may include, for example, a web browser, a vendor-specific application client, and/or processes for performing various aspects of a communication protocol (e.g., for implementing TCP/IP and interfacing the applications to the network 102).

The network interface circuitry may be operable to transmit and receive physical layer signals via the network. In the receive direction, the network interface circuitry may convert the signals to packets of binary data, and output the packets to the CPU and/or memory for processing. The network interface circuitry may, for example, receive signals in accordance with Ethernet physical layer protocols, assemble the signals to IP packets and output the IP packets to the CPU and/or memory. In the transmit direction, the network interface circuitry may receive IP packets from the CPU and/or memory, encapsulate the IP packets into Ethernet frames, and transmit the frames into the network 102 in accordance with Ethernet physical layer protocols.

In operation, a computing device 106 (referring to either or both of computing devices 106a and 106b) may access the electronic forum hosted by the computing device 104 using, for example, a web browser or vendor-specific “app” running on the computing device 106. The computing device may interact with the electronic forum using, for example, HTTP and/or a vendor specific API of the electronic forum. Packets containing requested information from the electronic forum may be transmitted into the network 102 by network interface circuitry and/or a CPU of the computing device 104. The packets may be received via network interface circuitry and/or CPU of the device 106 to recover the requested information and store it to memory of the device 106. The web browser or “app” running on the device 106 may then cause the requested information to be rendered for presentation (e.g., by the CPU) in a window on a monitor of the device 106. Similarly, packets containing data and/or commands to be submitted to the electronic forum may be transmitted into the network by the network interface circuitry and/or CPU of the device 106. The packets may be processed via the network interface circuitry and/or CPU of the device 104 to recover the commands and/or data and respond appropriately.

FIG. 1B is a high-level block diagram of a device that hosts an electronic forum in accordance with an example implementation of this disclosure. In the example implementation shown, the device 104 comprises memory 120 which stores posts of the electronic forum, memory 122 which stores user profiles of the electronic forum, notification generation circuitry 124, and user interface circuitry 128.

The user interface circuitry 128 is operable to act as an intermediary between the device 104 and client devices 106 accessing the electronic forum. The user interface circuitry 128 may, for example, operate as a web or application server which retrieves raw data from memory, formats it into user interface elements of a user interface of the electronic forum (e.g., encapsulates it with appropriate HTML tags), and then serves it to a client (e.g., a web browser running locally on device 104 or remote on a device 106).

The notification generation circuitry 124 is operable to parse the user profile data in memory 122 to identify the tags, mentions, and/or combinations of tags and/or mentions (referred to herein simply as “combinations”) to which users of the electronic forum are subscribed. The notification generation circuitry 124 is also operable to monitor the memory for new posts, and upon detecting creation of a new post, automatically inspect the post for occurrence(s) of the subscribed-to tags, mentions, and/or combinations. In response to detecting an occurrence of a subscribed-to tag, mention, or combination, the notification generation circuitry 124 may automatically notify the user(s) who are subscribed-to the detected tag, mention, or combination. In an example implementation, different users may have different permissions for different posts. In such an implementation, prior to notifying a user that a post has been created containing one of his/her subscribed-to tags, mentions, or combinations, the notification generation circuitry 124 first determine (based on the post data and the user profile data) whether the user has permission to view the post. If so, then the notification is sent. If not, then the notification may not be sent. In an example implementation, where the user does not have permission, the notification generation circuitry 124 may notify an owner/creator of the post or the thread in which the post was created to query whether the owner/creator wants to grant the user permission to view the post. In this regard, upon learning that the user is interested in tags, mentions, and/or combinations occurring in the post, the owner/creator may want to grant the user permission. In this manner, such notifications may provide for greater connectivity among users of the electronic forum and increased information sharing among users of the users of the electronic forum.

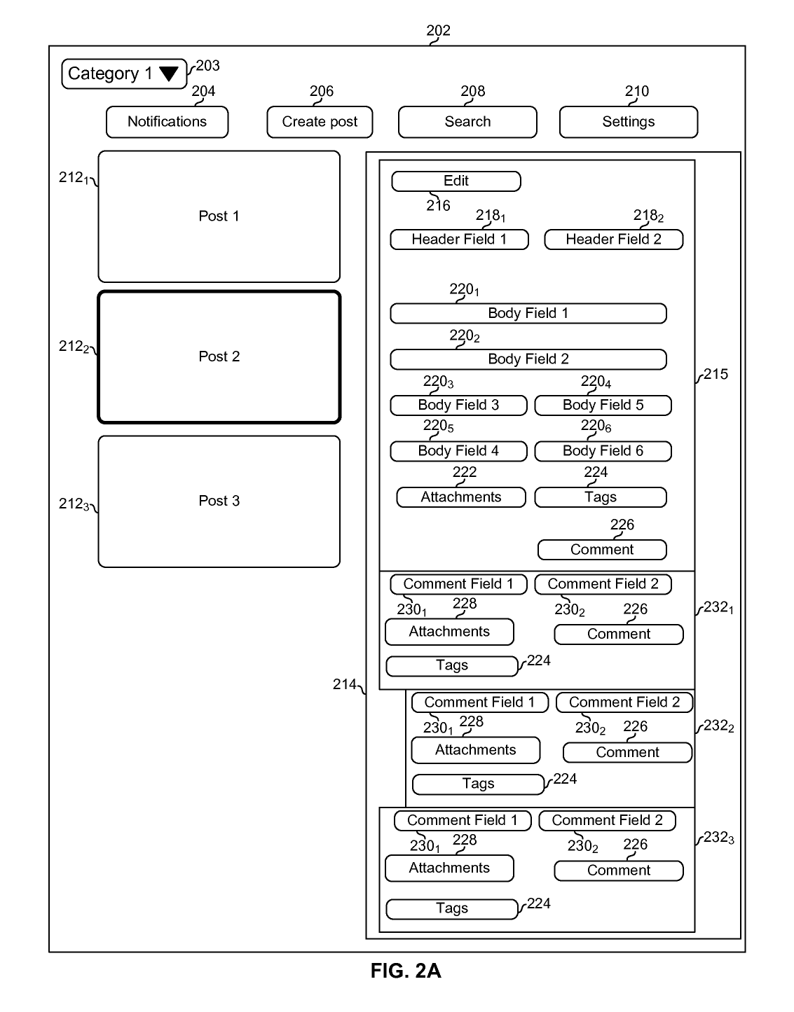

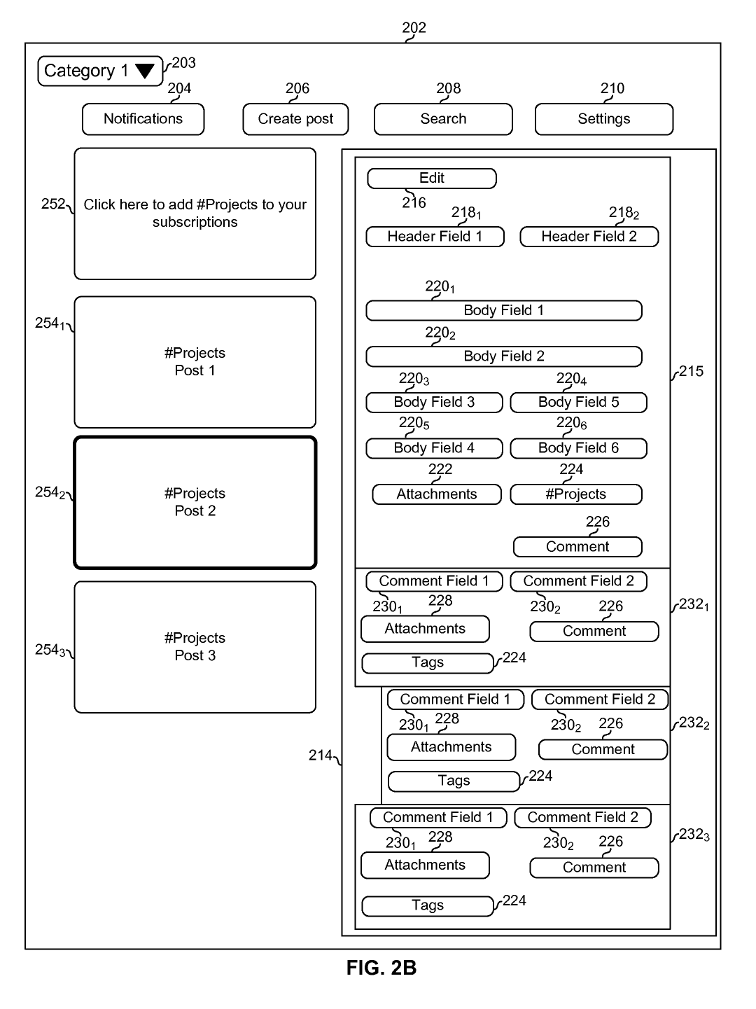

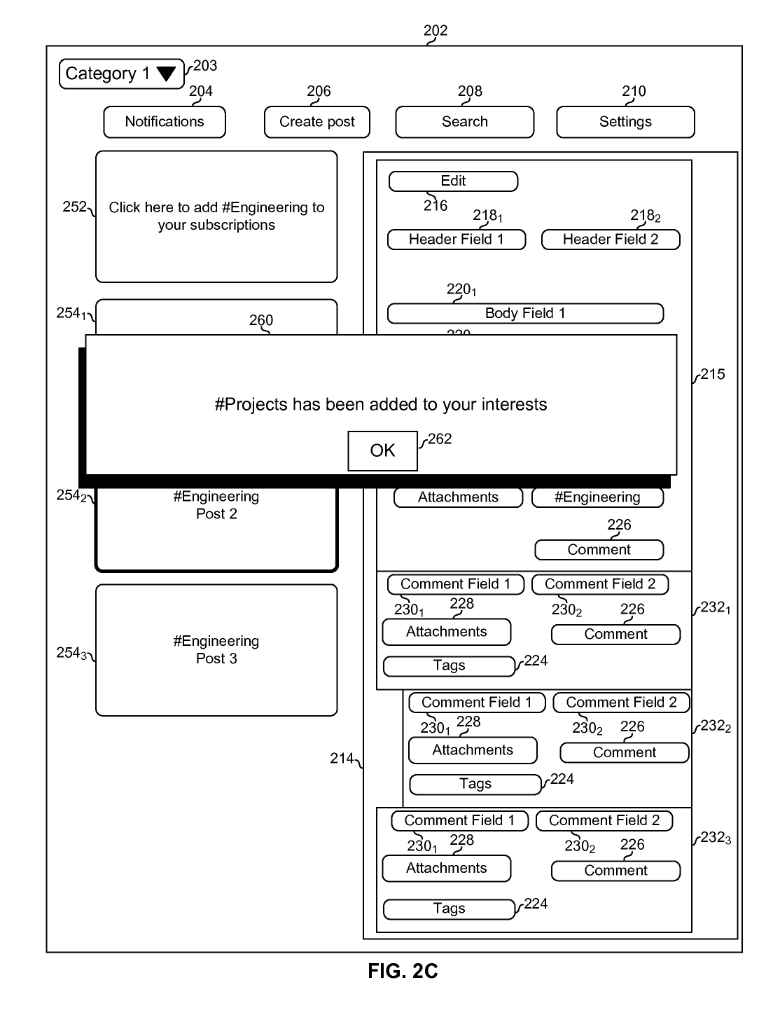

FIG. 2A depicts an example user interface of an electronic forum in which a first example post is selected for display. The window/screen 202 may, for example, be presented on a monitor of device 106a and be interacted with via a mouse and keyboard of the device 106a. The example window/screen 202 comprises a plurality of interface elements each which may be hyperlinks, text boxes, drop down menus, and/or the like.

Posts in the electronic forum may be categorized. Interface element 203 may enable a user of the forum to select a category of posts to view. For example, when interacted with, element 203 bring up a drop down list of categories to choose from. Examples below refer to a “real estate” category, but any category is possible.

When interacted with (e.g., touched, clicked, or the like), element 204, brings up an interface element in which notifications for the user are displayed (e.g., an “inbox” of messages, statuses, and the like pertaining to activity in the forum). In an example implementation, such notifications may be generated in response to creation of a post containing a subscribed-to tag, mention, or combination

When interacted with, element 206 brings up a post creation form for creating a new post. Upon submission of the form, a thread and/or post may be created in the electronic forum. A form for post creation in accordance with an example implementation can be found in the above-incorporated U.S. patent application Ser. No. 13/972,092.

When interacted with, element 208 brings up a search form for searching posts (including, for example, body fields, attachments, tags, etc.), comments, and/or any other contents of the forum. A search form in accordance with an example implementation can be found in the above-incorporated U.S. patent application Ser. No. 13/972,092.

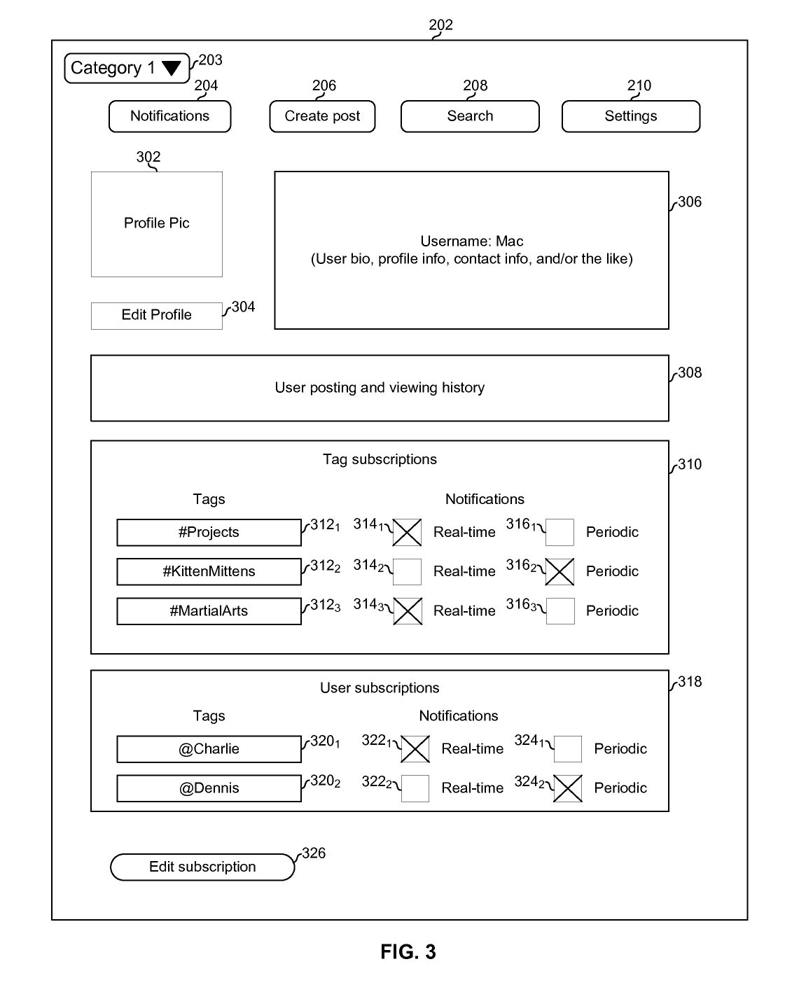

When interacted with, element 210 brings up a user profile window. An example user profile window is described below with reference to FIG. 3.

Each of the interface elements 212₁-212₃ corresponds to an existing post (“Post 1,” “Post 2,” and “Post 3,” respectively) stored in the electronic forum. Each of the posts may have been generated, for example, in response to a user filling out and submitting a post creation form.

The element 214 is a container for interface elements that correspond to the selected one of elements 212. For illustration, in FIG. 2A element 212₂ is selected (as indicated by the bold line around 212₂) and, therefore, in FIG. 2A element 214 contains information elements corresponding to Post 2.

The information corresponding to a post in the electronic forum may be stored, for example, in a data structure such as a table, a database, or the like. Accordingly, in an example implementation, generation of the element 214 for Post 2 may comprise the following: (1) in response to element 212₂ being selected (e.g., touched or clicked) on a client device viewing the forum (e.g., in a web browser or native app) a database record corresponding to Post 2 is fetched; (2) the record is parsed to recover components of Post 2 (which may include, for example, metadata/header fields of Post 2, content of Post 2, and/or other information); (3) an HTML file corresponding to the interface elements for presenting the retrieved components of Post 2 is generated based on the components of the post and the information from the form used to create the post; (4) the HTML file is transmitted to the client device; and (5) the HTML file is rendered for presentation on a monitor (e.g., using an applicable cascaded style sheet (CSS) file).

In an example implementation, a database record corresponding to a post in the electronic forum may comprise one or more first fields which may be populated with metadata/header information and a second field which may be populated with the contents of the post (which may include, for example, body fields, links to attachments, tags, and/or other information. The contents may be stored as structured text (e.g., in JavaScript Object Notation (JSON) form, XML format, or the like). A non-limiting example is shown below in Table 1.

TABLE 1

| Post ID | Content of Post |
|---|---|
| Post 3 | “Form 2”:{ |
| | “Header Field 1”:{“value”:“[Author's Name]”, |
| | “name”:“Header Field 1”}, |
| | “Header Field 2”:{“value”:“[Date of Post 3]”, |
| | “name”:“Header Field 2”}, |
| | “Body Field 1”:{“value”:“[user input to 220₁ of form 318₁]”, |
| | “name”:“Body Field 1”}, |
| | “Body Field 2”:{“value”:“[user input to 220₂ of form 318₂]”, |
| | “name”:“Body Field 2”}, |
| | “Attachments”:{“value”:“[path input to 343 of form 318₂)]”, |
| | “name”:“Attachments”}, |
| | “Tags”:{“value”:“[tag(s) based on Form 2 tag rule(s)]”, |
| | “name”:“Tags”} |
| | } |

The interface element 214 comprises an interface element 215 corresponding to the selected post (Post 2 in FIG. 2A), and one or more interface elements 232 corresponding to comments to the selected post. In the example of FIG. 2A, where Post 2 is selected, the interface element 214 comprises an element 215 and comment elements 232₁-232₃. The element 215 comprises an edit element 216, header field elements 218₁-218₂, body field elements 220₁-220₆, one or more attachment elements 222, one or more tags elements 224, and a comment element 226. Each of the comment elements 232₁-232₃ comprises elements 230₁ and 230₂, an attachments element 228, and an element 226.

When interacted with, the edit element 216 may bring up a form for editing Post 2. Upon submission of the form, the underlying structured data of Post 2 may be retrieved from memory (e.g., a database record associated with Post 2 may be retrieved, and the contents of the record may be parsed), updated to reflect the edits input via the form, and stored back to memory (e.g., overwriting the database record, adding to the database record, or creating a new database record). The window/screen 202 may then be refreshed to display the updated version of Post 2. Details of post-editing forms in accordance with an example implementation are described in the above-incorporated U.S. patent application Ser. No. 13/972,092.

Each of the header field elements 218₁ and 218₂ may present information about Post 2 that was not necessarily manually entered into the post creation form that generated Post 2, but is nevertheless associated with Post 2. For example, the metadata/header fields may present metadata associated with Post 2 such as a name of the author of Post 2, the time at which Post 2 was created, the time at which Post 2 was last edited, whether Post 2 has attachments, and/or the like.

Each of the body field elements 220₁-220₆ may present information entered into a field of the post creation form used to generate Post 2.

The attachment elements 222 may present hyperlinks to, or in-line renderings of, files (e.g., images, text files, pdf files, and/or the like) attached to Post 2 by its author.

The tags element 224 may present one or more tags associated with the post presented in element 215. Each tag may be presented as hyperlink that, when selected, triggers a search for other posts tagged with the selected tag and/or trigger presentation of an interface element for subscribing to the selected tag. In an example implementation, tags associated with Post 2 may be determined based on one or more tag generation rules associated with the post creation form used for generating Post 2, as, for example, discussed in the above-incorporated U.S. patent application Ser. No. 13/972,092.

The comment element 226 may, when interacted with, bring up a form for submitting a comment on Post 2. The comment may then be displayed in a corresponding element 232. In this regard, each of the elements 232₁ and 232₃ may present a comment on Post 2 that was submitted either by the author of Post 2 or another user of the electronic forum who has access to Post 2. Details of example comment generation forms are described below with reference to FIGS. 5A and 5B.

For each element 232_{X} (X representing here a value between 1 and 3 n FIG. 2A), each comment field elements 230_{Y} (Y representing here a value between 1 and 2 in FIG. 2A) may present header/metadata information associated with comment displayed in element 232_{X} and/or may present information entered into the comment generation form used to generate the comment element 232_{X}. Comment generation forms in accordance with an example implementation are described in the above-incorporated U.S. patent application Ser. No. 13/972,092.

For each element 232_{X}, the attachment element may present, for example, hyperlinks to, or in-line renderings of, files (e.g., images, text files, pdf files, and/or the like) attached to the comment presented in element 232_{X} by the comment's author.

For each element 232_{X}, the comment element 229 may, when interacted with, bring up a form for submitting a comment on the comment shown in element 232_{X}. The comment may then be displayed in an element 232_{Y} (Y representing here any value not equal to X). For example, the element 232₂ presents a comment on the comment shown in element 232₁.

Now referring to FIG. 2B, again shown is the screen 202 but this time, for illustration, an example tag of #Projects is shown in the tags element 224 of Post 2. As a result of a user selecting the #Projects tag, interface elements 252 and 254₁-254₃ are presented. Each of user interface elements 2541-2543 correspond to a post containing #Projects. That is, upon clicking #Projects in element 215 a search of other posts in the electronic forum that contain #Projects was triggered. Each search hit that the user has permission to view is then presented as an interface element 254. Thus, in the example shown, there are three other posts containing #Projects that the user has permission to view. Selection of one of the elements 254 causes the corresponding post and comments to be displayed in element 215 the same as Post 2 is displayed in FIG. 2A.

In response to the user selecting the interface element 252, the user is subscribed to #Projects and a dialog box 260 (shown in FIG. 2C) may be displayed to notify the user of the subscription. The user can clear away the dialog box by selecting interface element 262.

FIG. 3 shows an example user profile screen of the electronic forum. The screen is for an example user “Mac” and may be displayed in response to selection of interface element 210. The user profile screen comprises a profile picture interface element 302, user info element 306, element 304 for triggering a profile editing interface, element 308 presenting the user's historical activity in the electronic forum, interface element 310 presenting the user's tag subscriptions, interface element.

The interface element 308 may present, for example, past posts made by the user, past comments made by Mac, past posts viewed by Mac, past searches performed by Mac, and/or the like.

The interface element 310 comprises a plurality of interface elements 312, each of which corresponds to a tag the Mac is subscribed to. For each subscribed-to tag, Mac may select either a corresponding interface element 314 to have notifications for that tag sent in real-time (i.e., as soon as possible after creation of a post from, or referencing, the subscribed-to user), or an interface element 316 to have notifications of such posts sent periodically (e.g., hourly, daily, weekly, etc.).

The interface element 318 comprises a plurality of interface elements 320, each of which corresponds to another user of the electronic forum to whom Mac is subscribed. For each subscribed-to user, Mac may receive notifications when the subscribed-to user creates a post in the forum and/or when a post contains a “mention” of the subscribed-to user is created by a third user in the forum. For each subscribed-to user, Mac may select either a corresponding interface element 322 to have notifications for the subscribed-to user sent in real-time (i.e., as soon as possible after creation of a post from, or referencing, the subscribed-to user), or an interface element 324 to have notifications of such posts sent periodically (e.g., hourly, daily, weekly, etc.). In an example implementation, mentions and tags may be differentiated by use of one or more distinguishing alphanumeric characters. For example, tags may begin with the pound sign (#) and mentions may begin with the at sign (@). In such an implementation, #Mac would then be a tag that does not necessarily pertain to the electronic forum user Mac, whereas a mention of @Mac would definitely pertain to the electronic forum user Mac.

Upon being selected, the interface element 326 may trigger presentation of a user interface for Mac to add and/or remove tag and/or user subscriptions. In an example implementation, such a user interface may provide for crafting more advanced subscriptions using tags, mentions, and/or Boolean search terms. For example, Mac may be enabled to setup a subscription to be notified of posts that contain both a mention of @Dee and the tag #Paddy's.

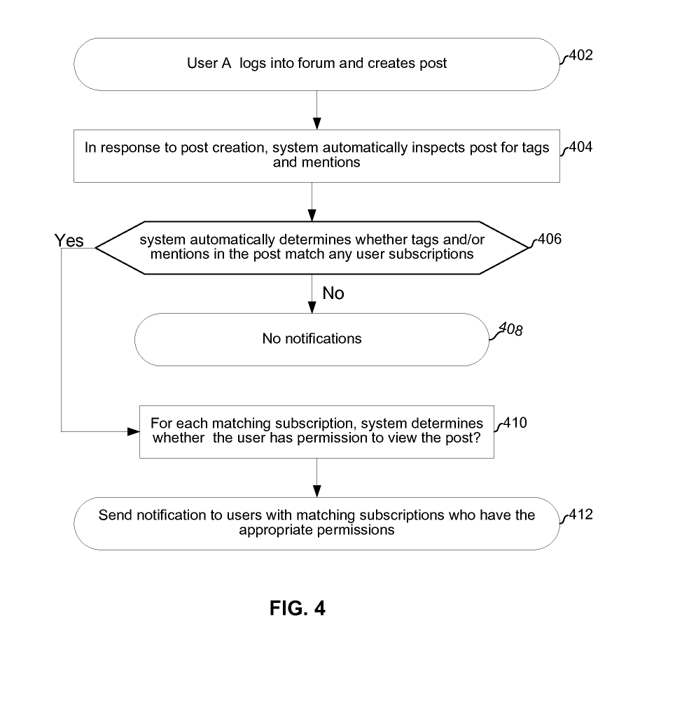

FIG. 4 is a flowchart illustrating an example process for real-time, interest-based notifications, in accordance with an example implementation of this disclosure. In block 402, User A logs into the electronic forum and creates a post containing the tag #Projects. In block 404, in response to the post creation in block 402, the system hosting the electronic forum automatically inspects (without user input required to trigger the inspection) the post to detect whether it contains any tags and/or mentions. In block 406, the system automatically determines (without user input required to trigger the determination) whether any tags and/or mentions in the post meet the tag, user, and/or combination subscriptions of any users of the electronic forum. If not, then in block 408 no notifications are sent.

Returning to block 406, if the tags and/or mentions in the post do match at least one subscription, then the process advances to block 410. In block 410, for each matching subscription, the system determines whether the user associated with the subscription has permission to view the post. Then, in block 412, the system sends a notification of the post to any users having a matching subscription and appropriate permissions.

In accordance with an example implementation of this disclosure, a system which hosts an electronic forum comprises: memory (e.g., 120) in which is stored profiles of users of the electronic forum, memory (e.g., 122) in which is stored posts of the electronic forum, and notification generation circuitry (e.g., 124). The notification generation circuitry is operable to, automatically in response to creation of a post to the electronic forum, inspect the post for an occurrence of a particular tag. The notification generation circuit is operable to determine, automatically in response to a detection that the post contains an occurrence of the particular tag, which of the users are both subscribed to the particular tag and have permission to view the post; and send, automatically in response to a determination that a first one or more of the users are both subscribed to the particular tag and have permission to view the post, a notification of the post to the first one or more of the users.

The system may also comprise user interface circuitry (e.g., 128). The user interface circuitry may be operable to serve user interface elements (e.g., elements contained in 214 of FIG. 2A) corresponding to the post (e.g., Post 2 of FIG. 2A), wherein one of the user interface elements (e.g., 124) comprises text of the particular tag (e.g., the text “#Projects”). The user interface circuitry may be operable to, in response to a user selecting the one of the user interface elements, serve a user interface element (e.g., 252) via which the user can subscribe to the particular tag. The user interface circuitry and the notification generation circuitry may be operable to in response to a user interface selecting the one of the user interface elements, search for other posts of the electronic forum which contain the particular tag, and present user interface elements (e.g., 254₁-254₃) corresponding to the other posts of the electronic forum which contain the particular tag. The automatic send of the notification may as soon as possible after the creation of the post (e.g., as soon as processing and/or network resources are available to perform the inspection, determination, and send). In some instances this may result in the notification be sent within, for example, 10 seconds of the creation of the post. In some instances this may result in the notification be sent within, for example, 10 minutes of the creation of the post.

The notification generation circuitry may be operable to inspect the post, automatically in response to the creation of the post, for a mention of a particular user of the users (e.g., look for @Dennis for a user of the electronic system having the username Dennis). The notification generation circuitry may be operable to determine, automatically in response to a detection that the post contains a mention of the particular user, which of the users are both subscribed to the particular one of the users and have permission to view the post. The notification generation circuitry may be operable to send, automatically in response to a determination that a second one or more of the users are both subscribed to the particular user and have permission to view the post, a notification of the post to the second one or more of the users. In this example implementation, all tags in the posts of the electronic forum, including the particular tag in the post, begin with a first one or more alphanumeric characters (e.g., the pound sign), and all mentions in the posts of the electronic forum, including the mention of the particular user in the post, begin with a second one or more alphanumeric characters (e.g., the at sign) different than the first one or more alphanumeric characters.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
performing by a computing system that hosts an electronic forum:
storing profiles of users of said electronic forum in memory;
storing posts of said electronic forum in memory;
inspecting, automatically in response to creation of a post to said electronic forum, said post for an occurrence of a particular tag; and
determining, automatically in response to detecting that said post contains an occurrence of said particular tag, which of said users are both subscribed to said particular tag and have permission to view said post; and
sending, automatically in response to determining that a first one or more of said users are both subscribed to said particular tag and have permission to view said post, a notification of said post to said first one or more of said users.

2. The method of claim 1, comprising:
performing by said computing system that hosts said electronic forum:
serving user interface elements corresponding to said post, wherein one of said user interface elements comprises text of said particular tag; and
in response to a user selecting said one of said user interface elements, presenting a user interface element via which said user can subscribe to said particular tag.

3. The method of claim 2, comprising:
in response to a user selecting said one of said user interface elements:
searching for other posts of said electronic forum which contain said particular tag; and
presenting user interface elements corresponding to said other posts of said electronic forum which contain said particular tag.

4. The method of claim 1, wherein said automatically sending said notification occurs within ten seconds of said creation of said post.

5. The method of claim 1, wherein said automatically sending said notification occurs within ten minutes of said creation of said post.

6. The method of claim 1, wherein:
all tags in said posts of said electronic forum, including said particular tag in said post, begin with a particular one or more alphanumeric characters.

7. A system comprising:
memory in which is stored profiles of users of an electronic forum;
memory in which is stored posts of said electronic forum;
notification generation circuitry operable to:
inspect, automatically in response to creation of a post to said electronic forum, said post for an occurrence of a particular tag; and
determine, automatically in response to a detection that said post contains an occurrence of said particular tag, which of said users are both subscribed to said particular tag and have permission to view said post; and
send, automatically in response to a determination that a first one or more of said users are both subscribed to said particular tag and have permission to view said post, a notification of said post to said first one or more of said users.

8. The system of claim 7, comprising user interface circuitry operable to:
serve user interface elements corresponding to said post, wherein one of said user interface elements comprises text of said particular tag; and
in response to a user selecting said one of said user interface elements, serve a user interface element via which said user can subscribe to said particular tag.

9. The system of claim 8, wherein said user interface circuitry and said notification generation circuitry are operable to:
in response to a user interface selecting said one of said user interface elements, search for other posts of said electronic forum which contain said particular tag; and
present user interface elements corresponding to said other posts of said electronic forum which contain said particular tag.

10. The system of claim 7, wherein said automatic send of said notification occurs within ten seconds of said creation of said post.

11. The system of claim 7, wherein said automatic send of said notification occurs within ten minutes of said creation of said post.

12. The system of claim 17, wherein:
all tags in said posts of said electronic forum, including said particular tag in said post, begin with a particular one or more alphanumeric characters.

13. A system comprising:
memory in which is stored profiles of users of an electronic forum;
memory in which is stored posts of said electronic forum;
notification generation circuitry operable to:
inspect, automatically in response to creation of a post to said electronic forum, said post for an occurrence of a particular combination of a plurality of tags; and
determine, automatically in response to a detection that said post contains said particular combination, which of said users are both subscribed to said particular combination and have permission to view said post; and
send, automatically in response to a determination that a first one or more of said users are both subscribed to said particular combination and have permission to view said post, a notification of said post to said first one or more of said users.
